(19) United States
(12) Patent Application Publication
(10) Pub. No.: US 2005/0220915 A1
(43) Pub. Date: Oct. 6, 2005

(54) Preparation method of nanoparticles

(75) Inventors: Hiroyuki Nakamura, Tosu-shi (JP); Hideaki Maeda, Tosu-shi (JP); Masaya Miyazaki, Tosu-shi (JP)

Correspondence Address: SUGHRUE MION, PLLC, 2100 PENNSYLVANIA AVENUE, N.W., SUITE 800, WASHINGTON, DC, 20037, US

(73) Assignee: NATIONAL INSTITUTE OF ADVANCED IND. SCIENCE AND TECH.

(21) Appl. No.: 11/023,388

(22) Filed: Dec. 29, 2004

Related U.S. Application Data
(62) Division of application No. 10/358,304, filed on Feb. 5, 2003.

(30) Foreign Application Priority Data
Feb. 5, 2002 (JP) 2002-28790

(51) Int. Cl. B28B 1/54

(52) U.S. Cl. 425/6

(57) ABSTRACT

A method of preparing a nanoparticle having a particle size of 1 nm to 1 μm, said method comprising continuously supplying a solution containing a particle-forming precursor into a micro channel having a diameter of 1 μm to 1 mm, said micro channel being disposed in a heating zone. The solution is heated rapidly up to a reaction initiation temperature to cause a reaction in said solution. The solution is rapidly cooled to prepare the nanoparticle.

### FIELD OF THE INVENTION

This disclosure teaches techniques related to continuously preparing product particles with particle size in the order of a nanometer from a solution containing a particle-forming precursor.

### BACKGROUND

Nanoparticles are used in many applications, including, as stable monochromatic fluorescence particles, magnetic particles, etc. Current research also includes efforts aimed at utilizing nanoparticles as building blocks of a wavelength-tunable light-emitting diode, monoparticle semiconductor, super-concentration magnetic storage medium and such other devices. Because of remarkable technical advances in various related fields in recent times, nanoparticles are being used in an increasingly wide range of application. Therefore, the demand for nanoparticles have increased rapidly.

Production of nanoparticles of metal such as gold, platinum and nickel, and compound such as titanium oxide, zinc oxide, cadmium selenide and zinc sulfide have been reported. Various techniques of preparing nanoparticles, such as a homogeneous precipitation method, a hydrothermal crystallization method and an organometallic synthesis method are conventionally known.

In order to obtain a desirable reduced size of the nanoparticle using a production process, in many cases, a number of nuclei are required to be formed. This also means that the concentration of a precursor, during the nucleus formation, needs to be sharply increased. This process inevitably leads to heterogeneity in the precursor concentration and increased temperature in a reaction system. This heterogeneity has a great affection on the particle size distribution of nanoparticles to be obtained. This adverse affect will be significant as the production facility is scaled up.

On the other hand, it is difficult to prepare nanoparticles on a mass production basis. To overcome this problem, a continuous preparation method has been conventionally attempted. However, these attempts have not succeeded in providing an effective technique.

Heretofore, to obtain nanoparticles with a desired particle size range the following technique has been used. Adequate raw materials are selected along with associated surfactants and other additions. A reaction temperature and reaction time is adjusted to control the rate of reaction of the raw materials or intermediate products and the rate of formation of the end product.

However, even if the reaction could be actually completed in a short period of time, the reaction rate is intentionally reduced due to the difficulty of controlling the reaction temperature and reaction time with a high degree of accuracy.

### SUMMARY

The disclosed teachings are aimed at overcoming the disadvantages in the conventional preparation methods of nanoparticles, and continuously preparing nanoparticles with a narrow particle size distribution while facilitating a highly accurate control of the reaction temperature and reaction time.

The disclosed teachings provide a method of preparing nanoparticles each having a particle size of 1 nm to 1 μm, preferably in the range of 1 to 20 nm, comprising continuously supplying a solution containing a particle-forming precursor (hereinafter referred to as “particle-forming precursor solution”) into a micro channel which has a diameter of 1 μm to 1 mm and is disposed in a heating zone, simultaneously heating the solution rapidly up to a reaction initiation temperature to cause a reaction in the solution, and then rapidly cooling the solution.

Another aspect of the disclosed teachings is a an apparatus for producing a nanoparticle, the apparatus comprising a micro channel with a diameter of 1 μm to 1 mm, with at least one source of input for a solution containing a nanoparticle-forming precursor. A heating zone is provided for heating the micro channel, where solution can be heated rapidly to a reaction initiation temperature. A collection vessel is provided for collecting a reaction product.

### BRIEF DESCRIPTION OF THE DRAWINGS

FIG. 1 is a schematic diagram showing one example of an apparatus suitable for implementing a method of the present invention;

FIG. 2 is a schematic diagram showing another example of an apparatus suitable for implementing a method of the present invention;

FIG. 3 is a transmission electron microscopic picture of gold colloid nanoparticles obtained in Example 1; and

FIG. 4 is a transmission electron microscopic picture of gold colloid nanoparticles obtained in Example 2.

### DETAILED DESCRIPTION

With reference to the drawings, the disclosed techniques are described in detail.

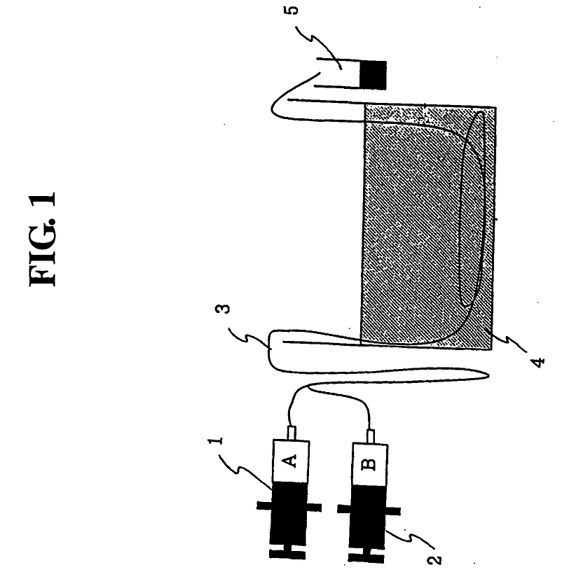

FIG. 1 schematically shows an example of an apparatus embodying the disclosed techniques. This apparatus uses two different kinds of particle-forming precursor solutions A and B. The two kinds of particle-forming precursor solutions A and B are simultaneously supplied to a micro channel such as a capillary tube 3 by their corresponding syringe pumps 1 and 2, and mixed together in the micro channel. The resulting mixture is transferred to a heating zone such as an oil bath 4, and rapidly heated up to a reaction initiation temperature in the heating zone 4. After reaction in the heating zone in the mixture, the reacted mixture is discharged from the heating zone 4 to the atmosphere, and rapidly cooled down. Finally, the reacted mixture is collected in a vessel 5. When the mixture passes through the heating zone 5, the product is precipitated in the form of nanoparticles.

If the two particle-forming precursor solutions do not react at room temperature but react only at a high temperature, these precursor solutions may be mixed together in advance. In such a case, the mixture is then supplied to the micro channel, and heated in the heating zone to generate nanoparticles. This causes turbulence and facilitates the mixing and the subsequent reaction that results in the creation of nanoparticles.

The micro channel 3 should be designed to have a diameter in the range of 1 μm to 1 mm. The reduced diameter of the micro channel reduces the ratio of the volume to surface area of the precursor solutions (or the mixed precursor solution) passing through the micro channel. Such a reduced ratio ensures that more of the solution can sufficiently receive the heat from an outside heating source or the heating zone in the quickest possible time. The solution also can more quickly respond to the changes in temperature of the outside heating source. This results in a rapid and highly accurate temperature control of the solution. In addition, the concentration of the solution can be controlled with a high degree of accuracy by reducing the width of the micro channel to provide a reduced diffusion length.

If the diameter of the micro channel is greater than 1 mm, the effectiveness of the apparatus deteriorates. In such a case, back mixing will occur at the front end due to turbulent flows. This makes it difficult to maintain evenly, the residence time of the solutions in the heating zone, thereby making it difficult to provide a narrow size distribution of the nanoparticles that are produced. If the diameter of the micro channel is less than 1 μm, it becomes very difficult to handle the micro channel. This also increases the pressure loss in the apparatus, deteriorating the production efficiency.

The material of the capillary tube may include glass, metal, alloy or plastic such as polyolefin, polyvinyl chloride, polyamide, polyester or fluororesin.

While the example in FIG. 1 uses a capillary tube as the micro channel, alternately the micro channel may be provided by forming a layer and then cutting a groove having a width of 1 nm to 1 μm on the surface of the layer. The layer could be made of, for example, metal oxides such as silica, alumina or titania. It could also be made of a heat-resistant plastic such as fluorinated resin, on a heat-resistant substrate, for example, made of metal or alloy,

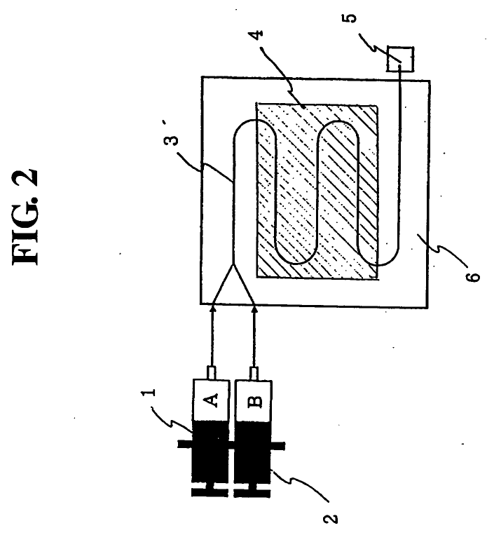

Another example having such a structure is schematically shown in FIG. 2. Specifically, a heat-resistant layer is formed on a substrate 6, and a groove 3′ serving as the micro channel is cut on the substrate 6. The mixture of the particle-forming precursor solutions A and B supplied to the groove 3′ is heated as it passed through the heating zone 4. The heating zone could be a heat plate. The solutions react in the heating zone and the product mixture is collected in the vessel 5.

While the examples in FIGS. 1 and 2 use two separate syringe pumps as material feeders, the particle-forming precursor solutions A and B may be supplied by using a single common feeder.

A heating device for the heating zone 4 may be composed of a bath with a heating medium such as oil as described above. Any other suitable conventional heating device such as a heat plate, an infrared heater, and a high-frequency heater may also be used.

According to the disclosed technique, the particle-forming precursor solution is preferably heated up to its reaction initiation temperature at a high heating rate of 5° C./sec or more in the heating zone. Such a rapid heating allows heat energy from outside to be transferred to the particle-forming precursor solution approximately without time lay. Thus, the reaction is formed in the solution very quickly to create a number of nuclei and consequently grow a number of particles so as to form nanoparticles having a small particle size. If the heating rate is less than 5° C./sec, the number of nuclei to be created will be reduced. This causes the particles to gradually grow around the respective nuclei at a lower speed. Thus, the particle size of the particles to be formed will be increased, and desired nanoparticles with a particle diameter 1 nm to 1 μm become harder to be obtained. Besides, in such a case, since the particle-forming precursor solution is gradually heated from its outer region toward its inner region, the reaction initiation timing and the particle growth time will be varied in the respective regions of the solution. Therefore, in such a case, the particle-size distribution cannot be controlled within a desired narrow range.

It is technically difficult to increase the heating rate in an unrestricted manner. Further, if an excessive number of nuclei are created, it will be practically impossible to supply the precursor at a concentration required for growing and forming particles corresponding to the nuclei. From this point of view, the heating rate is preferably set in a reasonable average range of 5° C./sec to 10,000° C./sec or more.

The nanoparticles formed in the heating zone in this way should be rapidly cooled immediately after the reacted solution exits the heating zone. The cooling rate is preferably set at 5° C./sec or more. A cooling rate of less than 5° C./sec will cause increased unevenness of the cooling, the reaction termination timing and the particle growth time in the respective regions of the reacted solution, resulting in undesirably expanded particle-size distribution.

The cooling may be done by means of natural cooling, air-cooling, oil-cooling or the like. Any conventional cooling device may be used. Further, the particle-forming precursor solution may be locally heated and cooled by a small-size heating element or Peltier element disposed around the micro channel.

In the disclosed technique the reaction is not restricted to any specific mode. Any suitable mode may be selected. According to one mode, one or more reactants in the form of solution are heated or mixed together to form a powdery solid. In another mode, insoluble compound particles are precipitated from plural kinds (e.g. two kinds) of soluble compounds. In yet another mode, one kind of soluble compound is pyrolytically decomposed to form powdery compound particles. Among these modes, one that provides a higher reaction rate or having a particle precipitation-rate to be significantly influenced by the reaction temperature or the concentration of chemical species is particularly preferable.

Such a reaction may include a reaction in which a reducer is reacted with a soluble metal compound solution to precipitate various kinds of metal particles. It may also include: a reaction in which carbonic acid is reacted with a calcium hydroxide solution to precipitate calcium carbonate particles, a reaction in which a sulfuric acid solution is reacted with a calcium chloride solution to precipitate calcium sulfide particles, a reaction in which a hydrogen sulfide solution is reacted with a cadmium chloride solution to precipitate cadmium sulfide particles, a reaction in which tetraalkoxysilane is thermally decomposed to precipitate silicon oxide particles, and a reaction in which a water-soluble selenium compound solution is reacted with a water-soluble cadmium compound solution to precipitate cadmium selenide particles.

The materials forming the nanoparticles using such a reaction may include: metal such as gold, silver, palladium, cobalt or nickel; metalloids such as silicon or germanium; metal or metalloid oxide such as zinc oxide, silicon oxide or germanium oxide; metal chalcogenide compound such as cadmium selenide, cadmium sulfide or zinc sulfide; and organic compounds such as organic complex compound or organic pigment.

The solvent of the particle-forming precursor solution used in the method of the present invention may be selected from: water; water-miscible organic solvent such as methyl alcohol, ethyl alcohol, acetone, dimethylformamide, dimethylacetamide or dimethyl sulfoxide; and water-immiscible organic solvent such as octane, cyclohexane, benzene, xylene, diethyl ether or acetic ether, depending on the type of precursor and the mode of reaction to be used.

In this case, an excessively high concentration of the precursor in the particle-forming precursor solution will increase the viscosity of the solution. This leads to a heterogeneous reaction having an adverse affect on the smooth formation of nanoparticles. If the precursor concentration is excessively low, the reaction rate will be reduced, and more time will be required for forming nanoparticles. Thus, the precursor concentration is typically set in the range of 0.001 to 5% by mass, preferably in the range of 0.01 to 1% by mass.

In the disclosed techniques, the particle size of nanoparticles to be formed can be controlled by adjusting the heating temperature and the residence time in the heating zone. In this process, the reaction temperature may be controlled by using a heating device having a temperature control function. The residence time may be controlled by adjusting the feeding rate of the particle-forming precursor solution or the volume of the micro channel, and introducing a certain gas or liquid into the micro channel to segment the solution. In this manner, the residence-time distribution of the solution can be maintained to be uniform to provide a narrow particle-size distribution. Such a residence time-distribution depends on the flow rate distribution, which in turn arises from the friction between the solution and the inner wall of the micro channel.

In this case, the gas to be used may include: inert gas such as nitrogen, argon or helium; oxidant gas such as air or oxygen; and reductant gas such as hydrogen or ammonia. The liquid to be used may include any suitable liquid which is not homogeneously mixed with the particle-forming precursor solution. For example, when the solution is a hydrophilic solution, the liquid may be a hydrophobic solvent such as hexane, cyclohexane or toluene. When the solution is a oleophilic solution, the liquid may be a hydrophilic solvent such as water, methyl alcohol, ethyl alcohol, dimethyl sulfoxide or dimethylformamide.

In the disclosed technique, the particle-forming precursor solution may be agitated to provide homogeneous reaction and reduced reaction time in the heating zone, as needed. This agitation may be performed using a micro stirrer, a mixing tube or an ultrasound device. The solution may also be agitated by mixing magnetic particles or magnetic fluid with the particle-forming precursor solution in advance, and applying a magnetic field thereto from outside.

In the disclosed techniques, a pump is used to continuously supply the particle-forming precursor solution to the heating zone. The pump is not limited to a specific type, but any suitable small-size pump may be selected. However, it is preferable to select a pump having low pulsations, such as a syringe pump or a non-pulsating pump.

In the disclosed techniques, when two kinds of particle-forming precursor solutions are used and reacted with one another in the heating zone, these solutions are preferably selected as a combination capable of forming different phases. These solutions are then made to react with one another along the interface between the different phases in the heating zone to form nanoparticles. In this case, the reaction can be homogeneously caused to provide nanoparticles having a constant particle-size distribution. The entire flow rate and reaction time can be readily controlled by changing the respective flow rates of the phases.

According to the disclosed techniques, nanoparticles with a particle size of greater than 1 μm can also be prepared. However, particles having an excessively increased size will sediment under gravity. These sedimented particles clog the micro channel and prevent the continuous operation of the apparatus. Thus, it is desirable to select the reaction conditions such that nanoparticles having a particle size in the range of 1 nm to 1 μm, preferably in the range of 1 to 20 nm are produced.

The disclosed techniques are described in more detail in conjunction with Examples, but not limited to these Examples.

### EXAMPLE 1

A micro reactor constructed as shown in FIG. 1 was prepared by immersing approximately one-half of the intermediate portion of a glass capillary tube having an inner diameter of 0.5 mm and a length of 1 m, into an oil bath having a volume of 500 ml.

A 1 mM-chloroauric acid solution and a 2% by mass of citric acid solution were fed from first and second syringe pumps, respectively, at a feed speed of 0.05 ml/minute, and mixed together before their introduction into the oil bath. Then, the mixture was introduced into the oil bath heated at 200° C. in advance, and rapidly heated up to 100° C. at a heating rate of 10° C./sec to cause a reaction in the mixture. Then, the reacted mixture was naturally cooled under ambient air, and collected in a vessel. In this case, the residence time in the oil bath was 10 minutes, and the cooling rate was 10° C./sec.

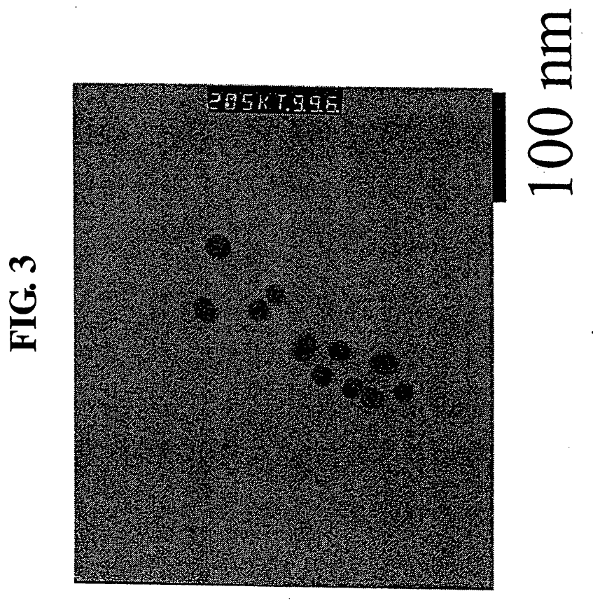

In this manner, gold colloid nanoparticles having an average particle size of 15 nm could be continuously obtained. A transmission electron microscopic picture of the obtained gold colloid nanoparticles is shown in FIG. 3.

### EXAMPLE 2

Based on a micro reactor using a hot water bath as a substitute for the oil bath of the micro reactor in Example 1, chloroauric acid was deoxidized by tannic acid and citric acid.

More specifically, a 1 mM-chloroauric acid solution and a solution containing 2% by mass of mixture consisting of tannic acid, citric acid and potassium carbonate (mass ratio: 5:7:4) were fed from the first and second syringe pumps, respectively, at a feed speed of 0.3 ml/minute, and mixed together. Then, the mixture was rapidly heated up to 60° C. in the hot water bath to cause a reaction in the mixture while applying ultrasounds from outside. Then, the reacted mixture was rapidly cooled under ambient air. In this case, the heating rate was 10° C./sec, the residence time being 1 minute, and the cooling rate being 10° C./sec.

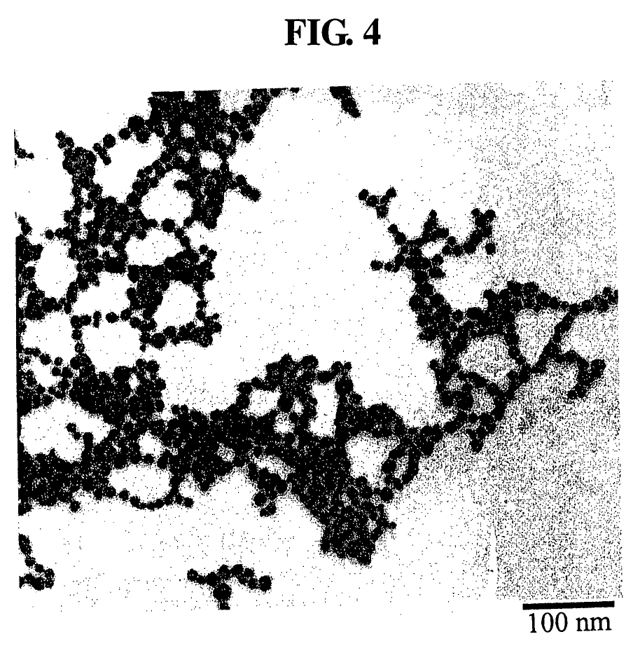

In this manner, gold colloid nanoparticles having an average particle size of 8 nm could be continuously obtained. A transmission electron microscopic picture of the obtained gold colloid nanoparticles is shown in FIG. 4.

### EXAMPLE 3

This example is based on a micro reactor having the same structure as that in Example 1 except that a single syringe pump was used as a substitute for the two syringe pumps. Further, the capillary tube had an inner diameter of 1 mm and a length of 700 mm. Further, cadmium sulfide particles were prepared through a homogeneous precipitation method.

More specifically, 50 mg/liter of cadmium sulfide, 60 mg/liter of thiourea, 500 mg/liter of sodium hexametaphosphate and 30 mg/liter of sodium hydroxide were dissolved in ion-exchange water. Then, the mixture was fed from the syringe pump to the capillary tube in the oil bath heated at 97° C. in advance, at a feed speed of 0.5 to 0.25 ml/minute to cause a reaction in the mixture. Then, the reacted mixture was rapidly cooled under ambient air.

In this case, both the heating rate and the cooling rate were maintained at a constant value of 5° C./sec, but only the residence time was changed between 2 minutes, 5 minutes and 10 minutes. The average particle sizes of gold colloid nanoparticles obtained in the respective conditions were judged from UV-VIS absorption spectrums. The result is shown in Table 1.

TABLE 1

| | Test No. | | |
|---|---|---|---|
| | No. 1 | No. 2 | No. 3 |
| Residence Time | 2 | 5 | 10 |
| Average Particle Size (nm) | 3.0 | 3.6 | 4.0 |

As seen in Table 1, the particle size of nanoparticles to be formed can be controlled by changing the residence time.

### EXAMPLE 4

This example is based on a micro reactor having a structure as shown in FIG. 1, provided with a micro channel composed of a capillary tube having an inner diameter of 0.2 mm and a length of 1.2 m. A single syringe pump was used. A mixed solution containing 70 g/kg of cadmium stealate, 300 g/kg of trioctylphosphineoxide, 90 g/kg of trioctylphosphineselenide and 280 g/kg of trioctylphosphine was fed at a feed speed of 0.1 to 0.01 ml/minute. The mixture was passed through the oil bath maintained at 275° C., and rapidly heated therein to cause a reaction. Then, the reacted mixture was rapidly cooled and then collected. The average particle sizes of gold colloid nanoparticles were measured and determined from UV-VIS absorption spectrums.

In this case, the heating rate was maintained at 3000° C./sec, and the cooling rate was maintained at 1000° C./sec. The residence time was changed between 0.5 minutes, 5 minutes and 10 minutes. The result is shown in Table 2.

TABLE 2

| | Test No. | | |
|---|---|---|---|
| | No. 1 | No. 2 | No. 3 |
| Residence Time | 0.5 | 5.0 | 10.0 |
| Average Particle Size (nm) | 3.4 | 3.8 | 4.2 |

As seen in Table 2, the particle size of nanoparticles to be formed can be controlled by changing the residence time.

### EXAMPLE 5

The residence time was maintained at 0.5 minutes, and the reaction temperature was changed from 245° C. to 320° C. Other conditions of the reaction were the same as those in Example 4. The average particle sizes of obtained cadmium selenide particles were determined. The result is shown in Table 3.

TABLE 3

Test No.

| | No. 1 | No. 2 | No. 3 | No. 4 |
|---|---|---|---|---|
| Reaction Temperature | 245 | 260 | 275 | 320 |
| (° C.) | | | | |
| Particle Size (nm) | 2.4 | 2.8 | 3.4 | 4.0 |

As seen in Table 2, the particle size of nanoparticles to be formed can be controlled by changing the reaction temperature.

As mentioned above, according to the present invention, particles having a controlled particle size of nanometer order can be continuously prepared by using a simple apparatus.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

1. An apparatus for producing a nanoparticle, the apparatus comprising:
a micro channel with a diameter of 1 μm to 1 mm, with at least one source of input for a solution containing a particle-forming precursor;
a heating zone for heating the micro channel, where the solution can be heated rapidly to a reaction initiation temperature; and
a collection vessel for collecting a reaction product.

2. The apparatus of claim 1, wherein the micro channel is a capillary tube.

3. The apparatus of claim 2, wherein the capillary tube is made using a material selected from a group consisting of glass, metal, alloy, a plastic, polyolefin, polyvinyl chloride, polyamide, polyester and fluororesin.

4. The apparatus of claim 1, wherein the micro channel is provided by a groove on a layer, said layer being on a heat resistant substrate.

5. The apparatus of claim 4, wherein the layer is made of a material selected from a group consisting of a metal oxide, silica, alumina, titania, a heat-resistant plastic, and fluorinated resin.

6. The apparatus of claim 4, wherein the heat-resistant substrate is a metal or an alloy.

7. The apparatus of claim 1 wherein the heating zone is made of a heat plate, an oil bath, an infrared heater or a high frequency heater.
